(19) United States
(12) Patent Application Publication
(10) Pub. No.: US 2026/0356011 A1
(43) Pub. Date: Nov. 12, 2026

(54) METHOD AND DEVICE FOR SEPARATING PARTICLES MADE OF DIFFERENT PLASTICS

(71) Applicant: D&G Recycling GmbH, Nördlingen (DE)

(72) Inventors: Jürgen Deinert, Duderstadt (DE); Andreas Götz, Nördlingen (DE)

(21) Appl. No.: 19/715,180

(22) Filed: Jun. 22, 2026

Related U.S. Application Data
(63) Continuation of application No. PCT/EP2024/086871, filed on Dec. 17, 2024.

(30) Foreign Application Priority Data
Dec. 22, 2023 (EP) 23 219 941.4

(51) Int. Cl. B29B 17/02; B03C 1/23

(52) U.S. Cl. CPC B29B 17/02; B03C 1/23; B29B 2017/0203; B29B 2017/0244; B29B 2017/0265; B29B 2017/0272

(57) ABSTRACT

For separating particles made of different plastics, the particles are suspended in a first liquid and separated into first light particles and first heavy particles based on density. The first heavy particles are dried and subjected to a first electrostatic separation based on dielectric properties, thereby obtaining at least a first fraction and a second fraction. Particles of the second fraction are electrostatically chargeable, whereas particles of the first fraction are not charged or are charged differently. The particles of the second fraction are then suspended in a second liquid having a higher density and separated into second light particles and second heavy particles. The second light particles are dried and subjected to a second electrostatic separation based on dielectric properties to obtain at least two additional fractions.

### CROSS REFERENCE TO RELATED APPLICATIONS

This application is a continuation of International Application PCT/EP2024/086871 with an international filing date of Dec. 17, 2024 and claiming priority to European Patent Application No. EP 23 219 941.4 entitled “Verfahren und Vorrichtung zur Trennung von Teilchen aus verschiedenen Kunststoffen”, filed on Dec. 22, 2023.

### FIELD

The present disclosure relates to a method and an apparatus for separating particles made of different plastics.

The recycling of plastics into high-quality products requires the separation of the plastics into single-material fractions. Such separation proves challenging even when no composite materials made of different plastics are present or when such composite materials can be separated by comminution into particles, each consisting of only one plastic material.

### BACKGROUND

A method for separating particles made of different plastics and a corresponding apparatus are known from registered German utility model DE 20 2021 000 353 U1. In order to produce a polyvinyl chloride (PVC) recyclate containing at most 1 wt. % polyolefins from cable recyclate, a sink fraction is first separated by means of a float/sink process at a separation density of 1.00 to 1.23 g/cm³. This sink fraction is mechanically dewatered by means of a centrifuge and additionally thermally dried. PVC is then separated from the sink fraction by means of electrostatic separation. Considerable effort is expended in mechanically pre-drying the sink fraction to a high degree of dryness with a residual moisture content of at most 0.4 wt. %. It is known that electrostatic separation can only be carried out at a residual moisture content of at most 0.2 wt. %, which must be achieved during the subsequent thermal drying. By means of the float/sink process, not only is a light fraction separated as such from the cable recyclate, but fractions are also removed that would prevent a specific charging of the PVC during electrostatic separation. After separation of the light fraction and the subsequent mechanical and thermal drying, the PVC is intended to be chargeable, owing to its position in the triboelectric series, in such a manner that rubber, fluoroelastomer, and silicone elastomer constituents present as foreign material can be separated electrostatically and the required purity as well as the desired material properties of the PVC can be achieved.

In addition, non-ferrous metals are separated in the known method between the drying step and the electrostatic separation by means of an eddy-current separator. It has been found that the known method is at best suitable for separating PVC particles from particles of other plastics.

United Kingdom patent application publication GB 2 465 839 A discloses a process for recycling plastics. Plastic waste is comminuted to an average particle size of 100 to 500 mm. Contaminants are removed by at least one means of a trommel screen, a ferrous metal separator or manually. The plastic waste is then comminuted to an average particle size of 50 to 150 mm. In a second contaminant-removal step, at least one of a non-ferrous metal separator or a plastic film separator is employed. Subsequently, the plastic material is granulated to an average particle size of 10 mm to 50 mm. The granulated plastic material is divided in a flotation tank into a sink stream and a floating stream of plastic material. The plastic material of at least one of the sink stream or of the floating stream is dried. A first optical separation is preferably performed using near-infrared technology. After the first optical separation, the plastic material is granulated to an average particle size of 2 to 10 mm. The granulated plastic material is then passed through a second flotation tank. Subsequently, the plastic material is dried and a second optical separation is carried out. Downstream of each optical separation, an electrostatic separation may be performed.

European patent application publication EP 2 484 506 A1 discloses a method for sorting and separating plastic waste. The plastic waste is comminuted. The resulting fragments are steam-cleaned. Using liquids of different densities, the fragments are separated in two density separators. In electrostatic separators, the density-separated fragments are further separated electrostatically.

There still is a need of a method and an apparatus for separating particles made of different plastics, by means of which additional high-quality single-material fractions of the particles can be obtained.

### SUMMARY

The present invention relates to a method for separating particles made of different plastics. The method comprises suspending the particles in a first liquid having a first density; separating the particles into first light particles having a density lower than the first density and first heavy particles having a density at least equal to the first density; drying at least one of the first light particles and the first heavy particles to obtain first dried particles; subjecting the first dried particles to a first electrostatic separation based on dielectric properties of the first dried particles to separate the first dried particles into at least a first fraction and a second fraction, wherein particles of the second fraction are electrostatically chargeable and wherein particles of the first fraction are not electrostatically charged or are electrostatically charged differently from the particles of the second fraction; suspending the electrostatically chargeable particles of the second fraction in a second liquid having a second density different from the first density; separating the electrostatically chargeable particles of the second fraction into second light particles having a density lower than the second density and second heavy particles having a density at least equal to the second density; drying at least one of the second light particles and the second heavy particles to obtain second dried particles; and subjecting the second dried particles to a second electrostatic separation based on dielectric properties of the second dried particles to separate the second dried particles into at least two additional fractions.

The present invention also relates to an apparatus for separating particles comprising different plastics. The apparatus comprises a first density separator configured to separate particles suspended in a first liquid having a first density into first light particles having a density lower than the first density and first heavy particles having a density at least equal to the first density; a first dryer configured and connected to the first density separator to dry at least one of the first light particles and the first heavy particles to obtain first dried particles; a first electrostatic separator configured and connected to the first dryer to subject the first dried particles to a first electrostatic separation based on dielectric properties of the first dried particles to separate the first dried particles into at least a first fraction and a second fraction, wherein particles of the second fraction are electrostatically chargeable and wherein particles of the first fraction are not electrostatically charged or are electrostatically charged differently from the particles of the second fraction; a second density separator configured and connected to the first electrostatic separator to separate electrostatically chargeable particles of the second fraction suspended in a second liquid having a second density into second light particles having a density lower than the second density and second heavy particles having a density at least equal to the second density; a second dryer configured and connected to the second density separator to dry at least one of the second light particles and the second heavy particles to obtain second dried particles; and a second electrostatic separator configured and connected to the second dryer to subject the second dried particles to a second electrostatic separation based on dielectric properties of the second dried particles to separate the second dried particles into at least two additional fractions.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWING

The invention can be better understood with reference to the following drawing. The components in the drawing are not necessarily to scale, emphasis instead being placed upon clearly illustrating the principles of the present disclosure.

FIG. 1 is a flow diagram of a method according to the present disclosure and, at the same time, a block diagram of an apparatus according to the present disclosure for separating particles made of different plastics.

### DETAILED DESCRIPTION

In a method according to the present disclosure for separating particles made of different plastics, the particles are suspended in a first liquid having a first density and are separated into first light particles having a density lower than the first density and first heavy particles having a density at least equal to the first density. At least the first light particles or the first heavy particles are dried to obtain first dried particles. The first dried particles are separated by a first electrostatic separation, based on their dielectric properties, into at least a first fraction and a second fraction, wherein the particles of the second fraction are electrostatically chargeable. During the first electrostatic separation, the particles of the first fraction, owing to their dielectric properties, are not electrostatically charged or are electrostatically charged differently from the electrostatically chargeable particles of the second fraction, such that the particles of the first and second fractions can be separated during the first electrostatic separation. The electrostatically chargeable particles of the second fraction are suspended in a second liquid having a second density and are separated into second light particles having a density lower than the second density and second heavy particles having a density at least equal to the second density. At least the second light particles or the second heavy particles are dried to obtain second dried particles. The second dried particles are separated by a second electrostatic separation, based on their dielectric properties, into at least two further fractions. By repeating the density separation using a second liquid whose second density differs from the first density of the first liquid by typically at least 0.10 g/cm³, the electrostatically chargeable particles of the second fraction are further subdivided, whereby additional single-material fractions can be obtained, such that it is indeed worthwhile to undertake the additional effort, in particular for the renewed drying of the particles after their second density separation using the second liquid.

According to the present disclosure, the method does not achieve the additional single-material particle fractions by means of what might appear to be an obvious direct succession of density separations of the particles using different liquids of different densities. Rather, after the first density separation, a first drying and a first electrostatic separation are carried out, and only one of the fractions thereby obtained, the particles of which are electrostatically chargeable, is subjected to the second density separation and then to renewed drying and a further electrostatic separation. The advantage of obtaining additional single-material particle fractions arises surprisingly; and only when the associated substantial additional drying effort, already mentioned above, is accepted are the additional single-material particle fractions obtained.

At least the respective liquid having the greater density, which is used in one of the density separations of the method according to the present disclosure, may be based on a solution of sodium phosphinate in water, i. e., the density may be adjusted by adding sodium phosphinate to water, wherein the liquid may additionally contain further additives in a limited amount of not more than 20 wt. % and generally not more than 10 or 5 wt. %. These additives may, for example, be surfactants that facilitate complete wetting of the particles with the respective liquid and prevent the inclusion of air bubbles. Both measures improve the quality of the density separation. Sodium phosphinate is readily soluble in water in order to achieve a liquid of the desired increased density. Above all, however, sodium phosphinate can readily be removed mechanically together with the liquid from the particles, and residues of sodium phosphinate remaining after drying do not interfere with the electrostatic separation of the particles in the method according to the present disclosure.

Insofar as surfactants are added to at least one of the first or second liquid in the method according to the present disclosure, care must be taken to ensure that these likewise do not impair the at least one subsequent electrostatic separation. Such impairment may be associated with the use of antistatic agents which, while being helpful for density separation, can be highly detrimental to a subsequent electrostatic separation because they may prevent the electrostatic charging even of particles that are fundamentally chargeable. Ethanol has proven to be a highly suitable surfactant that can be added to at least one of the first liquid or the second liquid without jeopardizing the at least one subsequent electrostatic separation. Specifically, at least one of the first liquid or the second liquid may contain 5 to 10 wt. % ethanol. Any accompanying reduction in the density of the respective liquid may be compensated by the addition of sodium phosphinate. The addition of ethanol to water does not restrict the solubility of sodium phosphinate in water to any extent relevant to the present disclosure.

The first density of the first liquid may be 1.00 g/cm³±0.03 g/cm³ or, more precisely, 1.00 g/cm³±0.01 g/cm³. Specifically, the first liquid may consist at least predominantly of water. At this first density, the first heavy particles having at least the first density may be dried to obtain the first dried particles. In other words, a light fraction having a density of less than 1.00 g/cm³ is separated by the first density separation using the first liquid. This light fraction may consist at least predominantly of low-density polyethylene (PE) and ethylene propylene diene monomer (EPDM). Here and elsewhere in this description and the appended patent claims, the term “predominantly” is to be understood in the sense that the substance from which the respective particles predominantly consist accounts for more than 50 wt. % of the particles.

In the first electrostatic separation, the first dried particles may be separated not only into the first fraction and the second fraction but also into a third fraction. In this case, the first fraction may comprise particles without a pronounced electrostatic charge, the second fraction may comprise particles having a positive electrostatic charge, and the third fraction may comprise particles having a negative electrostatic charge. The electrostatic charging occurring within the scope of the first electrostatic separation and the second electrostatic separation may, independently of one another, be caused by at least one of friction or electrical discharges. The charges of the individual particles after their electrostatic charging depend on their relative specific capacitances in the dimension of charge per area. The particles having the intermediate capacitance behave neutrally and form the first fraction. The particles having greater capacitances acquire a positive charge and form the second fraction; the particles having lower capacitances acquire a negative charge and form the third fraction of the three fractions.

Specifically, the particles of the first fraction may consist predominantly of PVC-P, whereas the particles of the third fraction consist at least predominantly of filled EPDM and other high-density ethylene propylene diene monomer (EPDM), that is, EPDM having a density greater than 1.00 g/cm³.

The second density of the second liquid, by means of which the second density separation is carried out, may be 1.23 g/cm³±0.03 g/cm³ or, more precisely, 1.23 g/cm³±0.01 g/cm³. If the second light particles are then dried to obtain the second dried particles, wherein the drying, like the drying to obtain the first dried particles, may be carried out first mechanically and then thermally, the second light particles may consist at least predominantly of polyamide (PA) and polyurethane (PU). By means of the second electrostatic separation, the second light particles may then be separated into a further fraction consisting at least predominantly of PA and another further fraction consisting at least predominantly of PU. The second heavy particles consist at least predominantly of at least one of fluoroelastomer, silicone elastomer, polyethylene terephthalate (PET) or cellulose acetate (CA).

In the method according to the present disclosure, electrically conductive particles may be separated, for example by means of eddy-current separation. In this case, the eddy-current separation may be carried out anywhere upstream of the first electrostatic separation in order to separate the electrically conductive particles beforehand. Otherwise, the electrically conductive particles enter the above-mentioned first fraction of particles without an electrostatic charge. However, eddy-current separation is not suitable for separating all electrically conductive particles. For example, ferromagnetic particles cannot be separated by eddy-current separation. In addition to particles of non-ferromagnetic metals, particles of electrically conductive plastics can also be separated by eddy-current separation.

Furthermore, ferromagnetic particles may be separated in the method according to the present disclosure. This is carried out in particular by magnetic separation using an electromagnet. The magnetic separation may likewise be carried out upstream of the first electrostatic separation. It also separates ferromagnetic electrically conductive particles that cannot be separated by eddy-current separation. By means of magnetic separation, particles of plastics that exhibit ferromagnetic properties due to corresponding metallic additives can also be removed.

Furthermore, electrically polarizable particles may be separated in the method according to the present disclosure. This may be carried out, for example, by separation using a strong electric-field gradient, which results in forces of differing magnitude acting on the particles in the direction of the electric-field gradient depending on their electrical polarizability.

In the method according to the present disclosure, the particle size of the particles at the beginning of their separation may be adjusted to a value within a range from 1 mm to 6 mm or from 2 mm to 6 mm, for example by grinding and sieving, and with a maximum tolerance of ±1.5 mm or only of ±1.0 mm. A particle size that is as uniform as possible for all particles eliminates influences of particle size that can in principle occur in density separation using a liquid, electrostatic separation, eddy-current separation, magnetic separation, and electric-field-gradient separation. For density separation and electrostatic separation, the particle size may be adjusted as precisely as possible but specifically within the range of 1 mm to 6 mm, with all particles falling within this range, such that the mean particle size is, depending on the maximum tolerance, between 2.5 and 4.5 mm or between 2 and 5 mm.

An apparatus according to the present disclosure for separating particles made of different plastics comprises a first density separator configured to separate the particles suspended in a first liquid having a first density into first light particles having a density lower than the first density and first heavy particles having a density at least equal to the first density. The apparatus further comprises a first dryer configured and arranged to dry the first light particles or the first heavy particles to obtain first dried particles, and a first electrostatic separator configured and arranged to separate the first dried particles by a first electrostatic separation, based on their dielectric properties, into at least a first fraction and a second fraction, wherein the particles of the second fraction are electrostatically chargeable. The apparatus further comprises a second density separator configured and arranged to separate the electrostatically chargeable particles of the second fraction, suspended in a second liquid having a second density, into second light particles having a density lower than the second density and second heavy particles having a density at least equal to the second density. A second dryer of the apparatus is configured and arranged to dry the second heavy particles or the second light particles to obtain second dried particles. The apparatus further comprises a second electrostatic separator configured and arranged to separate the second dried particles by a second electrostatic separation, based on their dielectric properties, into at least two further fractions.

The electrostatic separator may be configured and arranged to separate the first dried particles into the first fraction, the second fraction, and a third fraction, wherein the first fraction comprises particles without a pronounced electrostatic charge and wherein the second fraction comprises positively electrostatically charged particles and the third fraction comprises negatively electrostatically charged particles.

As already indicated, the dryers may each comprise mechanical and thermal components, for example a centrifuge and an infrared oven. Furthermore, the apparatus may additionally comprise, for example upstream of the first electrostatic separator, at least one of an eddy-current separator or a magnetic separator or an electric-field-gradient separator.

Commercially available industrial electrostatic separators employing electrostatic charging by at least one of friction or electrical discharges may be used as the electrostatic separators.

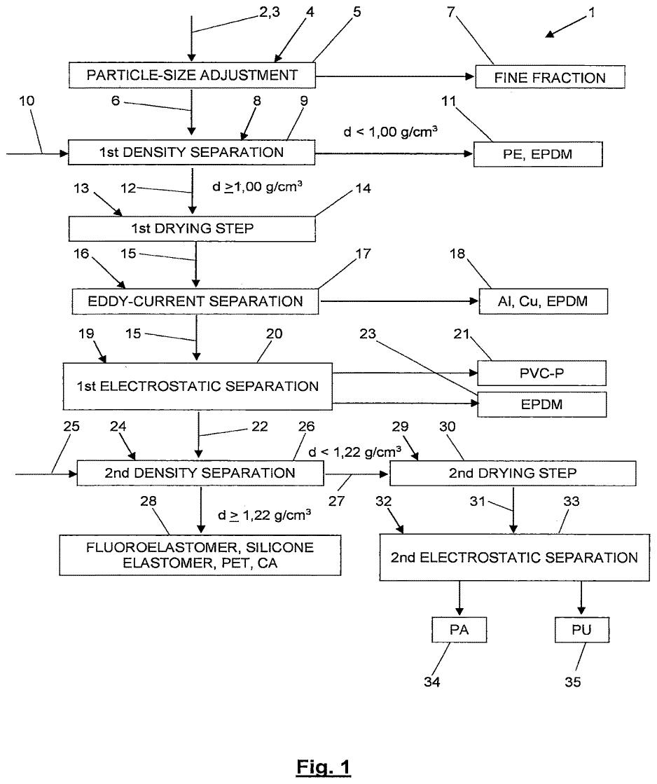

Now referring in greater detail to the drawing, FIG. 1 illustrates the sequence of a method according to the present disclosure and, at the same time, the structure of an apparatus 1 according to the present disclosure. The starting material 2 may be so-called cable recyclate 3, the principal constituents of which may be two or more of polyvinyl chloride with plasticizer (PVC-P), polyethylene (PE), polyamide (PA), polyurethane (PU), fluoroelastomer, silicone elastomer, ethylene-propylene-diene rubber (EPDM), polyethylene terephthalate (PET), cellulose acetate (CA), copper (Cu) or aluminum (Al). By grinding and sieving 4 in a particle-size adjustment device 5, particles 6 having a mean particle size in the range of 1 to 6 mm are obtained. In the process, a fine fraction 7, i.e., so-called fines, is separated from the particles 6.

In a subsequent first density separation 8 in a density separator 9, the particles 6 are suspended in a first liquid 10 having a first density of 1.00 g/cm³ and are then separated into floating first light particles 11 having a density of less than 1.00 g/cm³ and sinking first heavy particles 12 having a density of at least 1.00 g/cm³. The first light particles 11 are composed at least predominantly of particles of PE and low-density EPDM.

The first heavy particles 12 are subjected to a first drying step 13 in a first dryer 14. First dried particles 15 result from the first drying step 13. During an eddy-current separation 16 in an eddy-current separator 17, electrically conductive particles 18 that are not ferromagnetic are separated. The electrically conductive particles 18 consist at least predominantly of aluminum, copper, and electrically conductive EPDM.

The remaining first dried particles 15 are subjected to a first electrostatic separation 19 in a first electrostatic separator 20. In this process, the first dried particles 15 are separated into a first fraction 21, a second fraction 22, and a third fraction 23. The third fraction 23 comprises negatively electrostatically charged particles and consists at least predominantly of the higher-density EPDM not yet separated up to this point. The first fraction 21 comprises neutral particles, i.e., particles that are at most weakly electrostatically charged, and consists at least predominantly of PVC-P (plasticized polyvinyl chloride). The second fraction 22 comprises the positively electrostatically charged first dried particles 15.

The second fraction 22 is subjected to a second density separation 24 by means of a second liquid 25 having a density of 1.22 g/cm³ in a second density separator 26 and is thereby separated into second light particles 27 having a density of less than 1.22 g/cm³ and second heavy particles 28 having a density of at least 1.22 g/cm³. The second light particles 27 are dried in a second drying step 29 in a second dryer 30 to obtain second dried particles 31. The second dried particles 31 are subjected to a second electrostatic separation 32 in a second electrostatic separator 33.

By means of the second electrostatic separation 32, the second dried particles 31 are divided into two further fractions 34 and 35 consisting of particles having different electrostatic charges. In this case, one fraction 34 comprises the negatively charged or less strongly positively charged particles, which consist at least predominantly of PA, while the other fraction 35 comprises the more strongly positively charged particles, which consist at least predominantly of PU.

The second heavy particles 28 comprise particles of fluoroelastomer, silicone elastomer, PET, and CA and may likewise be dried and subjected to a further electrostatic separation, although this is not illustrated here.

The method according to the present disclosure utilizes both differences in the densities of the plastics contained in the starting material 2, i.e., the cable recyclate 3, and differences in electrostatic chargeability, as set forth in the following table. In this context, the capacitance in microcoulombs per square meter indicates the surface-specific electrostatic charge to which the particles (not rendered conductive) of the respective plastic can be electrostatically charged under identical conditions.

The electrostatic separation does not separate directly according to capacitance, i.e., according to the magnitude of chargeability. For electrostatic separation, a difference in capacitance must be present. In a mixture of three plastics, the plastic having an intermediate capacitance behaves neutrally during electrostatic charging, for example by friction, i.e., the corresponding particles are not significantly electrostatically charged. The particles of plastics having a high capacitance become positively charged; those having a low capacitance become negatively charged. This applies even though all of the listed plastics exhibit positive values for their capacitance. Thus, for example, PVC-P behaves neutrally, whereas PA, PU, PET, CA, silicone elastomer, and fluoroelastomer become positively charged, and PE and EPDM rubber become negatively charged.

| | Density [g/cm³] | Capacitance [μC/m²] |
|---|---|---|
| PVC-P | 1.30-1.50 | 84 |
| PE | 0.91-0.96 | 67 |
| PA | 1.03-1.08 | 96 |
| PU | 1.21-1.22 | 109 |
| PET | 1.38 | 101 |
| CA | 1.27-1.30 | 134 |
| EPDM-rubber | 0.96-2.10 | 55 |
| Silicone elastomer | 1.20-1.30 | 94 |
| Fluoroelastomer | 1.96-2.20 | 148 |

Many variations and modifications may be made to the preferred embodiments of the invention without departing substantially from the spirit and principles of the invention. All such modifications and variations are intended to be included herein within the scope of the present invention, as defined by the following claims.

We claim:

1. A method for separating particles made of different plastics, the method comprising:
suspending the particles in a first liquid having a first density;
separating the particles into first light particles having a density lower than the first density and first heavy particles having a density at least equal to the first density;
drying at least one of the first light particles and the first heavy particles to obtain first dried particles;
subjecting the first dried particles to a first electrostatic separation based on dielectric properties of the first dried particles to separate the first dried particles into at least a first fraction and a second fraction, wherein particles of the second fraction are electrostatically chargeable and wherein particles of the first fraction are not electrostatically charged or are electrostatically charged differently from the particles of the second fraction;
suspending the electrostatically chargeable particles of the second fraction in a second liquid having a second density different from the first density;
separating the electrostatically chargeable particles of the second fraction into second light particles having a density lower than the second density and second heavy particles having a density at least equal to the second density;
drying at least one of the second light particles and the second heavy particles to obtain second dried particles; and
subjecting the second dried particles to a second electrostatic separation based on dielectric properties of the second dried particles to separate the second dried particles into at least two additional fractions.

2. The method of claim 1, wherein the first liquid or the second liquid having the greater density is based on a solution of sodium phosphinate in water.

3. The method of claim 1, wherein the first liquid or the second liquid comprises from about 5 wt. % to about 10 wt. % ethanol.

4. The method of claim 1, wherein the first density is about 1.00 g/cm³±0.03 g/cm³, and wherein the first heavy particles are dried to obtain the first dried particles, wherein the first heavy particles are dried both mechanically and thermally.

5. The method of claim 4, wherein the first light particles consist by more than 50 wt. % of at least one of polyethylene or low-density ethylene propylene diene monomer.

6. The method of claim 4, wherein the first electrostatic separation separates the first dried particles into the first fraction, the second fraction, and a third fraction, wherein the first fraction comprises particles having substantially no electrostatic charge, the second fraction comprises positively charged particles, and the third fraction comprises negatively charged particles.

7. The method of claim 6, wherein the first fraction consists by more than 50 wt. % of plasticized polyvinyl chloride and the third fraction consists by more than 50 wt. % of higher-density ethylene propylene diene monomer.

8. The method of claim 1, wherein the second density is about 1.23 g/cm³±0.03 g/cm³, and wherein the second light particles are dried to obtain the second dried particles, wherein the second light particles are dried both mechanically and thermally.

9. The method of claim 8, wherein the second dried particles consist by more than 50 wt. % of polyamide and polyurethane and are separated by the second electrostatic separation into a first additional fraction consisting by more than 50 wt. % of polyamide and a second additional fraction consisting by more than 50 wt. % of polyurethane, and wherein the second heavy particles consist by more than 50 wt. % of at least one of fluoroelastomer, silicone elastomer, polyethylene terephthalate or cellulose acetate.

10. The method of claim 1, further comprising separating electrically conductive particles by eddy-current separation.

11. The method of claim 1, further comprising separating ferromagnetic particles by magnetic separation.

12. The method of claim 1, further comprising separating electrically polarizable particles by electric-field-gradient separation.

13. The method of claim 1, further comprising adjusting a particle size of the particles such that substantially all particles have a particle size between about 1 mm and about 6 mm.

14. The method of claim 13, wherein the particle size is adjusted with a maximum tolerance of about ±1.5 mm.

15. An apparatus for separating particles comprising different plastics, the apparatus comprising:
a first density separator configured to separate particles suspended in a first liquid having a first density into first light particles having a density lower than the first density and first heavy particles having a density at least equal to the first density;
a first dryer configured and connected to the first density separator to dry at least one of the first light particles and the first heavy particles to obtain first dried particles;
a first electrostatic separator configured and connected to the first dryer to subject the first dried particles to a first electrostatic separation based on dielectric properties of the first dried particles to separate the first dried particles into at least a first fraction and a second fraction, wherein particles of the second fraction are electrostatically chargeable and wherein particles of the first fraction are not electrostatically charged or are electrostatically charged differently from the particles of the second fraction;
a second density separator configured and connected to the first electrostatic separator to separate electrostatically chargeable particles of the second fraction suspended in a second liquid having a second density into second light particles having a density lower than the second density and second heavy particles having a density at least equal to the second density;
a second dryer configured and connected to the second density separator to dry at least one of the second light particles and the second heavy particles to obtain second dried particles; and
a second electrostatic separator configured and connected to the second dryer to subject the second dried particles to a second electrostatic separation based on dielectric properties of the second dried particles to separate the second dried particles into at least two additional fractions.

16. The apparatus of claim 15, wherein the first density is about 1.00 g/cm³±0.03 g/cm³.

17. The apparatus of claim 16, wherein the first dryer is configured and connected to the first density separator to dry the first heavy particles.

18. The apparatus of claim 15, wherein the first electrostatic separator is configured to separate the first dried particles into the first fraction, the second fraction, and a third fraction, wherein the first fraction comprises particles having substantially no electrostatic charge, the second fraction comprises positively charged particles, and the third fraction comprises negatively charged particles.

19. The apparatus of claim 15, wherein the second density is about 1.23 g/cm³±0.03 g/cm³.

20. The apparatus of claim 19, wherein the second dryer is configured to dry the second light particles.
